(19) United States
(12) Patent Application Publication
(10) Pub. No.: US 2008/0288440 A1
(43) Pub. Date: Nov. 20, 2008

(54) SEARCHING AND INDEXING CONTENT IN UPNP DEVICES

(75) Inventor: Eki Monni, Espoo (FI)

Correspondence Address: PERMAN & GREEN, 425 POST ROAD, FAIRFIELD, CT, 06824, US

(73) Assignee: NOKIA CORPORATION, Espoo (FI)

(21) Appl. No.: 11/749,256

(22) Filed: May 16, 2007

(51) Int. Cl. G06F 17/30

(52) U.S. Cl. 707/1; 707/E17.002

(57) ABSTRACT

A method including providing a mediator at an access point in a network, the mediator being configured to communication with UPnP devices coupled to the network, detecting a search request from a search engine in the network, using the mediator to search and retrieve content from each UPnP device coupled to the network, the retrieved content being related to the search request, converting the retrieved content into a protocol suitable for the search engine, and passing the retrieved content from the mediator to the search engine.

### BACKGROUND

1. Field

The disclosed embodiments generally relate to searching for content in electronic and computing devices, and in particular to searching content in Universal Plug and Play (UPnP) devices and platforms.

2. Brief Description of Related Developments

Computing devices are generally configured to allow a user to search the device for content, which can include for example, applications, programs, files and documents. These devices can also be configured to search other devices or platforms for content, such as for example over the Internet. Search engines and machines, such as desktop and Internet search facilities, do not currently search content that resides on UPnP devices. Rather, search engines only search for content that is resident on the user's personal computer (desktop search) or through HTTP servers (Internet Search). Content that resides on UPnP type devices is not visible to these search engines. There can be however, a great deal of content that is of interest in UPnP devices. It would be advantageous to be able to search this content using traditional search facilities, such as a desktop search and/or Internet search.

UPnP is a technology that enables easy-to-use peer-to-peer connectivity of wireless devices, intelligent home appliances, PCs and other types of stand-alone devices from different vendors. The UPnP standard specifies how devices supporting UPnP connect together to form an ad-hoc proximity network. The UPnP standard enables control and data transfer among the networked devices by specifying the required protocol exchanges. UPnP is a technology standardized by the UPnP Forum and the Digital Living Network Alliance (DLNA).

Various types of UPnP devices exist. Some of the most well known UPnP devices are media servers, whose functionality is generally to store text, pictures, audio and video content. This content can be transferred from the media server to a UPnP supporting television, a video screen or computer screen, or other suitable audio or video device. However, to this point, this content has not been available to be searched by the typical desktop or Internet search engines.

Modern search facilities, such as for example Google™ or Yahoo Search™, work in such a way that they continuously fetch content from content providers, and build an index of that content (words, phrases, and nowadays even pictures, video and audio). Based on the index built, it is possible for users to perceive fast search operations.

However, as mentioned, these search machines do not currently search content residing in UPnP devices. They merely search and index content that is available through HTTP servers (Internet search) or at user's personal computer (desktop search). If users want to search content residing in UPnP devices, they must utilize the search capabilities of each independent UPnP device. However, many UPnP devices do not support such searching. It is possible that there are no search capabilities available at all, or the device supports only manual search—the user may need to open each file and manually find items looked for. In some devices the only reasonable way to search the content of the UPnP device may be to copy the whole content to a PC or another device supporting some kind of search functionality and perform the search there.

EP 1379049 discloses a system with UPnP devices that exchange web page information. Devices such as printers can search and request web page information over the UPnP protocol, particularly if one device asks another device to output data. However, EP 1379049 does not address the situation of being able to search the content stored on a UPnP device using a traditional search facility or engine.

Since there can be a lot of different kinds of content in UPnP devices, it would be advantageous if this content could be searched by search machines, using Internet search, desktop search or both.

### SUMMARY

In one aspect, the disclosed embodiments are directed to a method. In one embodiment the method includes providing a mediator at an access point in a network, the mediator being configured to communicate with UPnP devices coupled to the network, detecting a search request from a search engine in the network, using the mediator to search and retrieve content from each UPnP device coupled to the network, the retrieved content being related to the search request, converting the retrieved content into a protocol suitable for the search engine, and passing the retrieved content from the mediator to the search engine.

In a further aspect, the disclosed embodiments are directed to an apparatus. In one embodiment the apparatus includes a computing network, at least one computing device coupled to the network, at least one device compliant with the Universal Plug and Play standard coupled to the network and a mediator system coupled to the network, the mediator system configured to be an interface between a search facility of the at least one computing device and each device coupled to the network. The mediator is further configured to detect a search request from the search facility, search and retrieve content from each UPnP device coupled to the network, the retrieved content being related to the search request, convert the retrieved content into a protocol suitable for the search facility and pass the retrieved content from the mediator to the facility.

In yet another aspect, the disclosed embodiments are directed to a computer program product. In one embodiment, the computer program product comprises a computer useable medium having computer readable code means embodied therein for causing a computer to execute a set of instructions in a device to search for UPnP content in UPnP devices. The computer readable code means in the computer program product includes computer readable program code means for causing a computer to detect a search request from a search engine in the network, computer readable program code means for causing a computer to search and retrieve content from each UPnP device coupled to the network, the retrieved content being related to the search request, computer readable program code means for causing a computer to convert the retrieved content into a protocol suitable for the search engine and computer readable program code means for causing a computer to pass the retrieved content from the mediator to the search engine.

### BRIEF DESCRIPTION OF THE DRAWINGS

The foregoing aspects and other features of the embodiments are explained in the following description, taken in connection with the accompanying drawings, wherein:

FIG. 1 shows a block diagram of a system in which aspects of the disclosed embodiments may be applied;

FIG. 2. is a block diagram of one example of a system incorporating features of the disclosed embodiments;

FIG. 3. is a block diagram of an exemplary system incorporating features of the disclosed embodiments;

FIG. 4. is a flow chart of one example of a method incorporating features of the disclosed embodiments;

FIG. 5A is a flow chart of one example of a method incorporating features of the disclosed embodiments;

FIG. 5B is a flow chart of one example of a method incorporating features of the disclosed embodiments;

FIGS. 6A and 6B are exemplary screen shots in accordance with an embodiment;

FIG. 7 is one example of a device incorporating features of the disclosed embodiments;

FIG. 8 illustrates one example of a schematic diagram of a network in which aspects of the disclosed embodiments may be practiced; and

FIG. 9 illustrates a block diagram of an exemplary apparatus incorporating features that may be used to practice aspects of the disclosed embodiments.

### DETAILED DESCRIPTION OF THE EMBODIMENT(S)

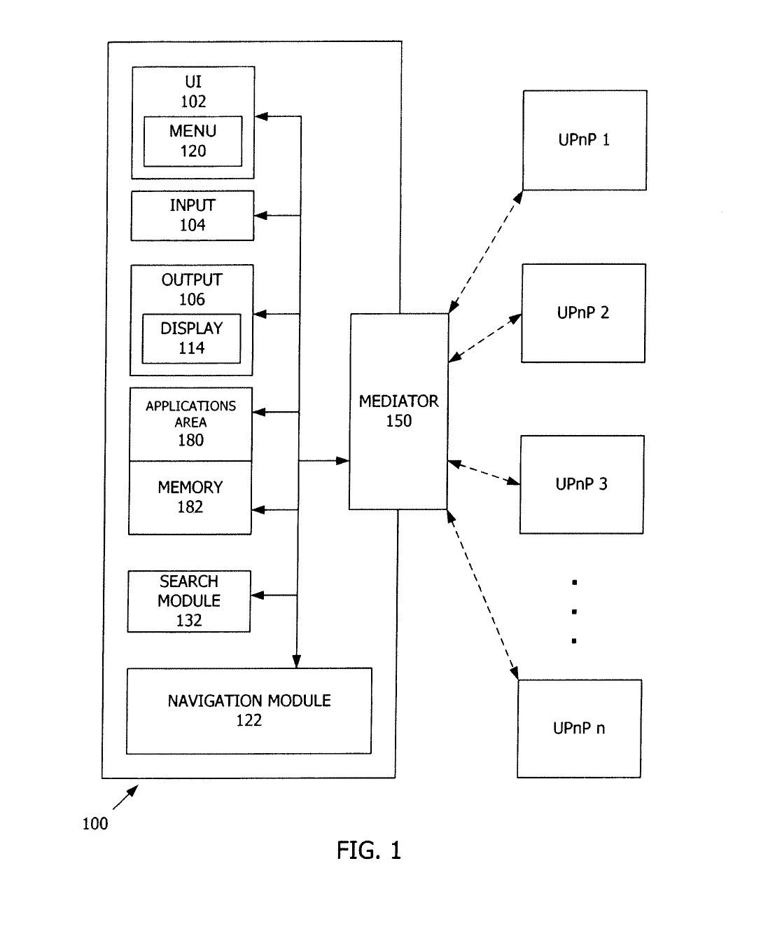

Referring to FIG. 1, one embodiment of a system 100 is illustrated that can be used to practice aspects of the claimed invention. Although aspects of the claimed invention will be described with reference to the embodiments shown in the drawings and described below, it should be understood that these aspects could be embodied in many alternate forms of embodiments. In addition, any suitable size, shape or type of elements or materials could be used.

The disclosed embodiments generally allow a user of a device or system, such as the system 100 shown in FIG. 1 to search for content in UPnP type devices using search facilities, including but not limited to, typical desktop or Internet-based search engines. The disclosed embodiments make content that resides on these UPnP devices available to search facilities without the need for manipulation of the content prior to search or the need to move such content into another facility or device prior to searching. The disclosed embodiments allow the content of UPnP devices to be open to general search facilities and engines so that users can search not only their computing device and Internet pages, but also the content of any UPnP device coupled to their system.

The system 100 of FIG. 1 generally includes a user interface 102, input device 104, output device 106, applications area 180 and storage/memory device 182. The components described herein are merely exemplary and are not intended to encompass all components that can be included in a system 100. While the user interface 102, input device 104 and output device 106 are shown as separate devices, in one embodiment, the input device 104 and output device 106 can be part of, and form, the user interface 102.

In one embodiment, the input device 104 receives inputs and commands from a user and passes the inputs to, for example, navigation module 122 for processing. The navigation module 122 may be part of the user interface 102. In alternate embodiments the navigation module 122 may be separate from the user interface 102. The output device 106 can receive data from the user interface 102, application area 180 and storage device 182 for output to the user. Each of the input device 104 and output device 106 are configured to receive data or signals in any format, configure the data or signals to a format compatible with the application or device 100, and then output the configured data or signals. While a display 114 is shown as part of the output device 106, in other embodiments, the output device 106 could also include other components and devices that transmit or present information to a user, including for example audio devices and tactile devices. For example, with respect to the embodiments described herein, the user interface 102 generally comprises a touch screen display. The output device 106 can be configured to provide the content of the exemplary screen shots shown herein, which is presented to the user via the functionality of the display 114. User inputs to the touch screen display are processed by, for example, the input device 104. The input device 104 can also be configured to process new content and communications to the system 100. Thus, the user interface 102 of the embodiments described herein, can include aspects of the input device 104 and output device 106.

In the disclosed embodiments, the user can enter the search criteria into a search engine of the device or a search engine accessible to the device. The navigation module 122 can interpret the commands and, in the case of a search request, can pass the request to a search module 132, for example. The search module 132 can comprise any suitable search facility or engine, including but not limited to, those mentioned previously herein (e.g. Internet search engines), search engines that provide local search results (e.g. data stored locally in the device or attached UPnP devices) or a combination thereof for example. In one embodiment, the navigation module 122 can also include a module 150 or search engine that is configured to interact with any UPnP device UPnP1-UPnPn connected to the system 100. This module 150 is referred to herein as the “mediator” module. The mediator module 150 is generally configured to make content that is resident on a UPnP device accessible to the search module 132 for searching. In one embodiment, the mediator module 150 can be configured to appear and act as an HTTP server. In alternate embodiments, the mediator module 150 may be configured to appear and act as any suitable server having any suitable communication protocol including, but not limited to, IP, TCP, UDP, HTTP and XML. Thus, when a user enters a search request into the system via the user interface 102, the search can proceed through all available content, which can include for example, the user's desktop computer or computer system, the Internet, and now any UPnP device that is connected to or coupled to the system 100.

It should be noted that although the mediator module 150 is described with respect to the ability to search for content on UPnP devices, in alternate embodiments, the searching of a UPnP device can be carried out without a separate mediator module or device. For example, in one embodiment, if a UPnP device is searched using a standard file server application program interface (“API”) such as GNOME virtual file system (“VFS”), the UPnP device could provide a mediator style or configured API itself.

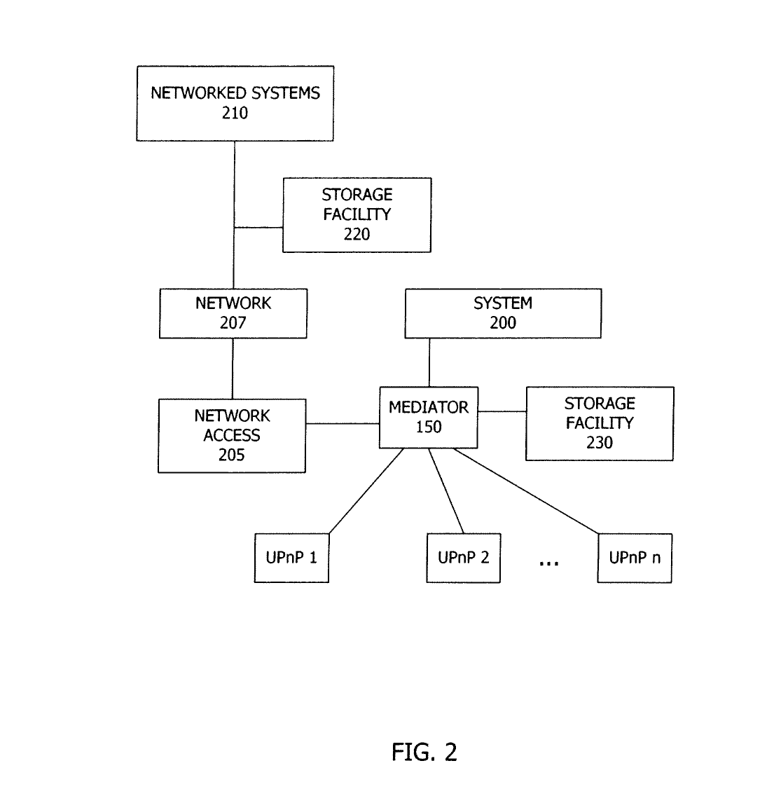

In one embodiment, referring to FIG. 2, the mediator 150 of FIG. 1 can be coupled to a user's network access point 205. The network access point may connect the user's system with a network 207. The network may be any suitable network including, but not limited to, the Internet, the world wide web, local area network, wide area network and cellular network. The network may include networked systems 210 such as, for example, Internet servers, other user systems, storage devices, and/or other UPnP devices. The mediator 150 also forms a link between the user's network access point and each UPnP device UPnP1-UPnPn coupled to the system. The mediator 150 can use standard UPnP protocols to fetch UPnP device content from each UPnP device UPnP1-UPnPn coupled to the system 200 in response to a search request. The system 200 may be substantially similar to system 100 described above. To the search engine, the mediator 150 will appear as a compatible server such as an HTTP server. The mediator 150 will mediate the content retrieved from each UPnP device UPnP1-UPnPn into a format accessible through, for example, an HTTP server. The mediator 150 will map the UPnP protocols to Internet protocols for placement in a content index. The content of the UPnP device does not need to be separately formatted in order to be searchable by the mediator module or search engine 150. The mediator 150 can be configured to read and retrieve any content. Any required formatting can be carried out prior to or at delivery of the content to the requester.

The search device, such as the search module 132 of system 100 or, for example, an Internet based search engine, can the retrieve content from each of the UPnP devices UPnP1-UPnPn that are responsive to the search query. The search device(s) or facility can then populate their databases with the retrieved content. Thus, as users enter search queries into the search engines, the search results will include content from the various UPnP devices. In one embodiment, the system can be configured to disable searching of one or more UPnP devices coupled to the system, depending upon the search requirements and criteria. This can allow for selective searching of certain types of UPnP devices or non at all, and can avoid tying up resources carrying out unnecessary searches

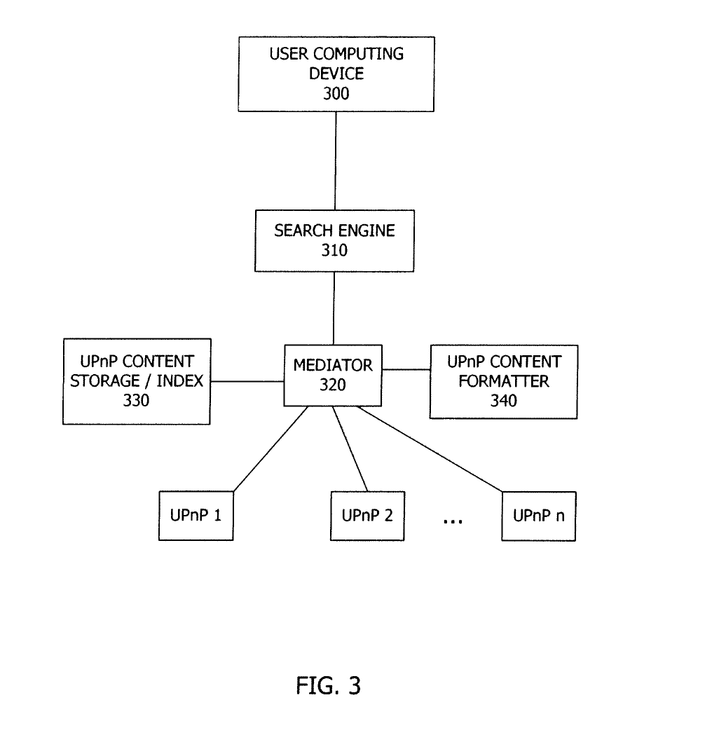

In one embodiment, referring to FIG. 3, a user computing device 300 is in communication with a search engine or facility 310 and a mediator 320. The search engine 310 and mediator may be integral with the computing device 300, the may be part of a separate system or any combination thereof. The computing device may be any suitable device as will be described below. The mediator 320 can be used to fetch and store content from each of the UPnP devices UPnP1-UpnPn using UPnP protocols. A content storage facility 330 can be used to store the retrieved content. In one embodiment, the content that is retrieved can be indexed. As the content is retrieved, the content can be formatted into a suitable protocol. In one embodiment, the content can be formatted into a protocol of a search facility in response to the search request from the search engine 310. As UPnP devices are coupled to the system, their content can be retrieved and stored. In one embodiment the content of each connected UPnP device can be retrieved automatically when the device is connected. In other embodiments the content of each newly connected UPnP device may be gathered by the mediator 320 and indexed when a search is initiated so that the next time a search is performed that content will be indexed for faster searching. In still other embodiments, the mediator 320 may periodically retrieve the content from each connected UPnP device so that newly added UPnP device content is retrieved and an updated list or index of UPnP device content is maintained.

When a search request or query is initiated or at a time when the mediator 320 retrieves UPnP content as described above, the mediator 320 will execute a search of the UPnP devices UPnP1-UPnPn and retrieve and store the content. As the retrieved content is passed to the search facility, such as for example, search engine 310 for storage and indexing, the formatter 340 will format the content into a suitable protocol. In one embodiment, the indexing of the UPnP content may be performed by the mediator 320. In other embodiments the indexing of the UPnP content may be performed by the search facility 310 when the UPnP content is passed to it by the mediator 320.

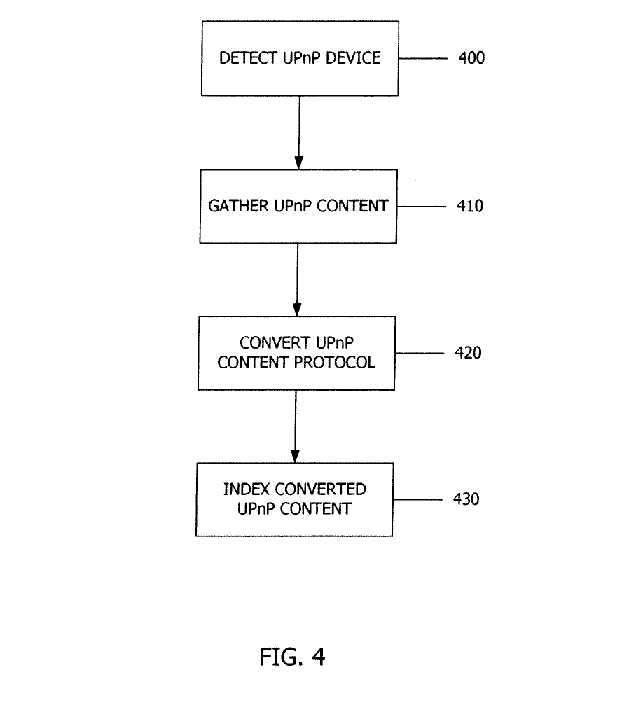

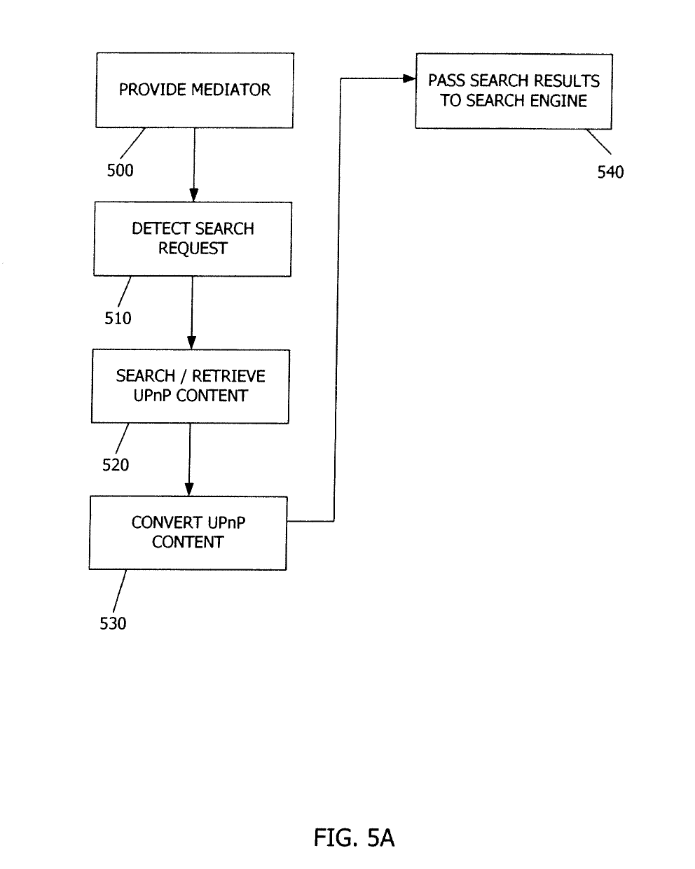

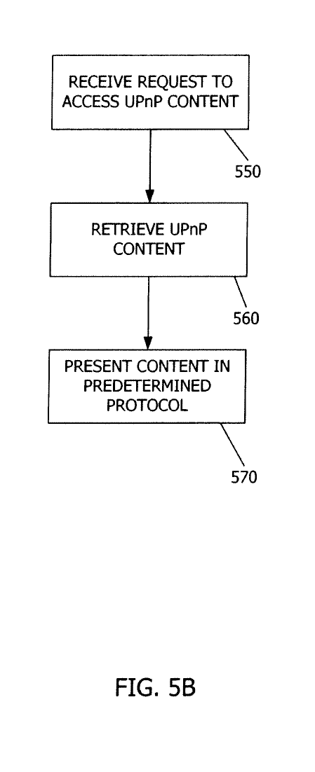

Referring now to FIGS. 4-6B the operation of some aspects of the disclosed embodiments will be described. A mediator 150 is provided in a system such as system 200 shown in FIG. 2. (FIG. 5A, Block 500). The mediator 150 may be integrated into the system 200 in any suitable manner. For example, in one embodiment the mediator 150 may be a standalone unit similar to a cable or DSL modem that plugs into the system. In another embodiment, the mediator may be part of the electronics within a device such as described above with respect to FIG. 1. In still other embodiment, the mediator may be provided on a computer card such as, for example, smart cards, memory cards (e.g. flash cards, USB memory drives), PCI or PCMCIA cards. In another embodiment, the mediator may have any suitable connection to the system including but not limited to wired or wireless connections.

In one embodiment, when a UPnP device is connected to the system, which includes the mediator 150, the UPnP discovery protocol allows that device to advertise its services to control points in the network. The Mediator 150 may be considered one of these control points. Additionally, if the mediator is added to a system in which UPnP devices are already connected, the UPnP discovery protocol allows the mediator 150 to search for devices of interest that are connected to the system. (FIG. 4, Block 400). The UPnP device may be any suitable device having universal plug and play compatibility including, but not limited to, media servers, audio/visual equipment, appliances (e.g. refrigerators, stoves, freezers, washers, dryers, etc.), heating/ventilation/air conditioning equipment, gaming consoles, cameras, personal computers and communication devices. The mediator 150 may retrieve, for example, device descriptions from the discovered UPnP devices. The mediator 150 may also gather or retrieve UPnP content or at least a list of content stored within the UPnP devices. The content formatter 340 (See FIG. 3) of the mediator 150 converts or mediates the UPnP content into a protocol that is compatible with search engines or facilities that may be utilized to search, for example, the system, the Internet and/or UPnP content. (FIG. 4, Block 420). The converted UPnP content may be passed to the search facility for indexing or the mediator 150 may index the content so that the content is available to be accessed during a search query. (FIG. 4, Block 430). The indexed list of UPnP content may be kept by the search facility and/or the mediator 150 even when the UPnP from which the content originated is disconnected from the network or system. If a user selects UPnP content from the search results for a device that is no longer connected to the system the mediator 150 and/or search engine may present the user with a message that the UPnP device is not currently connected and provide the user with an option to be notified when that UPnP device is reconnected to the system.

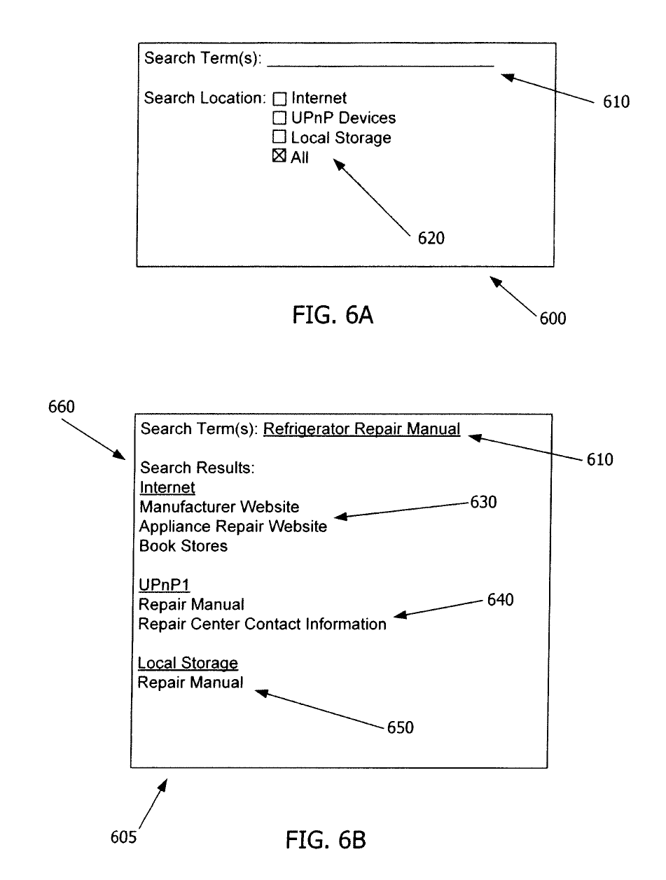

In accordance with another embodiment, after the mediator 150 is provided (FIG. 5A, Block 500) as described above, the mediator 150 detects a search request or query. (FIG. 5A, Block 510). An exemplary search screen 600 of, for example, a search engine in system 100 is shown in FIG. 6A. A user may utilize this screen to initiate a search request. As can be seen in the figure the search screen 600 includes a search criteria area 610 and search selections 620 that may allow a user to specify where the search is to be conducted. In this example, the user may specify that the search is to be performed using the Internet, UPnP devices connected to the system, local storage devices such as, for example, hard drives and memory cards or all of the above. The user may be able to select one or more of the search selections to that any combination of search selections may be specified. In one embodiment the default search selection is “all” search areas. In alternate embodiments any search selection may be set as the default selection. In other embodiments no default selection is provided. It is noted that the search screen 600 is only exemplary in nature and in other embodiments any suitable information and/or selections may be input or presented to the user in any suitable manner.

Referring back to FIG. 2, the search query may be initiated by any suitable device or system such as by, for example, a system 200 that is local to the mediator 150 or by a networked system 210 connected to the mediator 150 by the network access point 205. The mediator, in response to the search request, searches the connected UPnP devices and retrieves content from the UPnP devices that is pertinent to the search request. (FIG. 5A, Block 520). The mediator converts the retrieved UPnP content to a protocol compatible with the search engine or facility through which the search request was made and passes the converted content to the search engine or facility for indexing and presentation to a user. (FIG. 5A, Blocks 530, 540). An exemplary search result screen 605 is shown in FIG. 6B. As can be seen in FIG. 6B the search result screen 605 may include a summary of the search criteria 610 and a list of search results 660. In this example, the search results are categorized by location 630-650. For example, here the user searched for a refrigerator repair manual. The results of the search indicate that information pertaining to the repair manual was found on the Internet, in UPnP device UPnP1 and in a local storage device. The user may select an appropriate search result item for presentation to the user.

Referring also to FIG. 5B, in one embodiment, the mediator 150 may only pass an indication or synopsis (e.g. keywords or key phrases) of the retrieved UPnP content to the search engine to facilitate faster searches such that the transmission of the entire UPnP content does not slow down or clog the network connections. Here when the synopsis of the retrieved UPnP content is presented to a user, the user may select one of the search results to obtain more information. The search engine may send a request to the mediator 150 to access the full information pertaining to the selected UPnP content. (FIG. 5B, Block 550). The mediator 150 either retrieves the information from an index or storage in which the UPnP content is kept or retrieves the UPnP content directly from a corresponding UPnP device. (FIG. 5B, Block 560). When the information is retrieved by the mediator 150 it is converted as described above and passed on to the search facility for presentment to the user. (FIG. 5B, Block 570).

Although the above embodiments are described as being implemented generally in a system or device, it will be understood that the disclosed embodiments can be practiced on any suitable device. For example, the device 100 of FIG. 1 can generally comprise any suitable electronic device, such as for example a personal computer, a personal digital assistant (PDA), a mobile terminal, a mobile communication terminal in the form of a cellular/mobile phone, or a multimedia device or computer. In alternate embodiments, the device 100 of FIG. 1 may be a personal communicator, a mobile phone, a tablet computer, a laptop or desktop computer, a television or television set top box a DVD or High Definition player or any other suitable device capable of containing for example a display 114 shown in FIG. 1, supported electronics such as the navigation module or processor 122 and memory 182 and supporting software or hardware.

Referring back to FIG. 1, the user interface 102 can also include a menu system 120. The menu system 120 can provide for the selection of different tools and application options related to the applications or programs running on the device 100. The navigation module 122 provides for the control of certain processes of the device 100, such as the search engine or module 132 and mediator device 150. In the embodiments disclosed herein, the navigation module 122 receives certain inputs, such as for example, signals, transmissions, instructions or commands related to the functions of the device 100. Depending on the inputs, the navigation module interprets the commands and directs the search module 132 and mediator device 150 to execute the commands accordingly.

For example, the user may navigate the menu 120 using the input device 104 so that a search screen such as, for example, the search screen 600 is presented to the user through for example the display 144 of the output device 106. The input device may be any suitable input device including, but not limited to, any suitable keypad (e.g. QWERTY or ITU-T), rotator inputs, microphones and touch sensitive inputs and associated styli. In one embodiment, the input device 104 can be integral to the device 100. In alternate embodiments the input 104 may be a peripheral display connected or coupled to the device 100. The output device may be any suitable output device including, but not limited to, CRT displays, LCD displays with optional back lighting, such as a TFT matrix capable of displaying color images, plasma displays, graphical user interface and speakers. In other embodiments the input and output devices may be combined such as, for example, in a touch sensitive display. A pointing device, such as for example, a stylus, pen or simply the user's finger may be used with the display 114. In alternate embodiments any suitable pointing device may be used. In one embodiment, the display 114 can be integral to the device 100. In alternate embodiments the display may be a peripheral display connected or coupled to the device 100.

In one embodiment the search screen 600 may be an extension of the search module 132. In other embodiments the search screen 600 may be part of the menu system 120 and associated with the search module 132 via the navigation module 122. The user may use the input device 104, which may form part of the user interface 102, to input a search criteria and any other pertinent information that may be used in searching for content in for example the UPnP devices UPnP1-UPnPn. The navigation module recognizes the input pertaining to the search criteria and forwards the request to the search module 132. The search module 132 may cause a search to be performed through connected devices including, but not limited to the UPnP devices UPnP1-UPnPn. For example, in one embodiment, the mediator 150 detects the search request and searches the UPnP content index for UPnP content related to the search criteria. In other embodiments, the mediator 150 may also search the UPnP devices in addition to searching the content index so that any content added to the UPnP devices after the last content index update is gathered (and also stored in the content index) in response to the search request. The mediator 150 is configured to search the UPnP devices using, for example, UPnP protocols so that the user does not have to remove the content from the UPnP devices and store that content in a device that is compatible with the search module 132 or otherwise manipulate the UPnP content so that it may be searched. The mediator 150 is also configured to mediate or convert the UPnP content into a protocol that is compatible with the search module 132 such as for example, the HTTP protocol or any other suitable protocol as described above. The converted UPnP content is passed to the search module 132 by the mediator 150 and is caused to be presented to the user via the display 114 by, for example, the navigation module 122. As the user selects the UPnP content presented in, for example the search result screen 605 of FIG. 6B, the navigation module 122 may start the appropriate application in the applications area 180 so that the content item can be viewed or listened to. For example, where the selected UPnP content item is a picture, the navigation module 122 may start a picture viewer of the applications area 180 so that the user can view the picture from the UPnP device. Where for example, the UPnP content is a video the navigation module 122 may cause a video application to be launched so the video may be played and so on.

It is noted that the mediator 150 may be configured by a user so that only certain UPnP content can be accessed through the search facilities to protect the user's identity or preserve the user's privacy. For example, the mediator 150 may have a setup menu in, for example the menu 120 that allows an owner of the UPnP device to specify which content is to be made publicly available to public search engines, such as Internet search engines. When a UPnP device is connected to a system that allows public access to the UPnP content by third parties, the owner of the UPnP device may be able restrict the third party's access (e.g. access rights) to the UPnP content. In alternate embodiments, when the UPnP device is connected to a home or local network (i.e. the UPnP content is not available to the general public) a user may be able to configure the mediator 150 so that family members such as children are restricted from accessing UPnP content that may be inappropriate for the children. In other alternate embodiments the UPnP content may be restricted in any suitable manner.

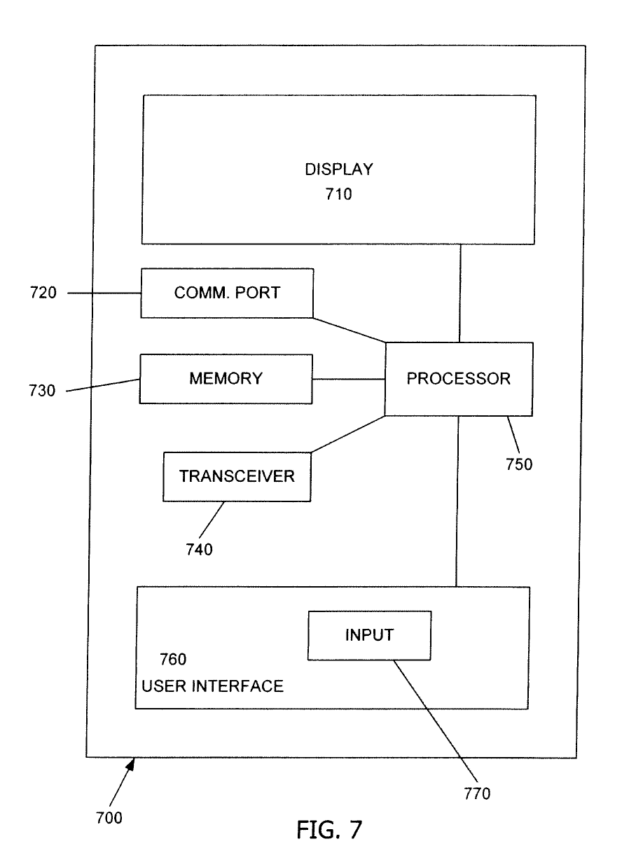

Referring now to FIG. 7, another exemplary device 700 incorporating aspects of the disclosed embodiments is shown. In this embodiment the device 700 may be any suitable device as described above. The device includes a display 710, a processor 750, a user interface 760 with input 770, communication ports 720, memory 730 and transceiver 740. The display 710, user interface 760 and input 770 may be substantially similar to that described above with respect to FIG. 1. The processor 750 may be configured to perform the functionalities of, for example, the navigation module 122, mediator 150 and/or search module 132 described above. The memory 730 may include the UPnP content index and any device applications including, but not limited to, word processors, calendars and multimedia players (e.g. video, music, pictures, etc.). As can be seen in FIG. 7 the device 700 also includes communication port 720. The communication port may be any suitable communication that allows the device 700 to be connected to any suitable system or network including one or more UPnP devices. The communication port 720 may include any suitable wired or wireless connections including, but not limited to, USB, firewire, serial, parallel, infrared, and blue tooth. In alternate embodiments the communication port 720 may allow the device 700 to be connected directly to a UPnP device so that the UPnP content can be searched via the device 700. The device 700, may also include a transceiver 740 for wireless communication with, for example a cellular network. The transceiver 740 may allow the device to connect to the Internet via a cellular connection so that searching of UPnP device connected to the Internet can be searched.

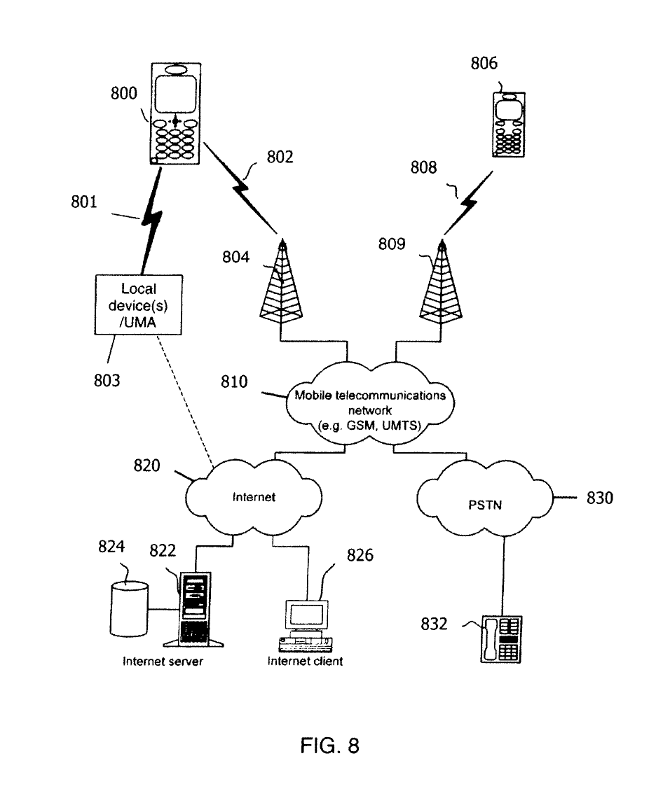

Referring to FIG. 8, one embodiment of a communication system in which the disclosed embodiments can be used is illustrated. In the communication system of FIG. 8, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 800 and other devices, such as another mobile terminal 806, a stationary telephone 832, or an Internet server 822. It is to be noted that for different embodiments of the mobile terminal 800 and in different situations, different ones of the telecommunications services referred to above may or may not be available. The aspects of the invention are not limited to any particular set of services in this respect.

The mobile terminals 800, 806 may be connected to a mobile telecommunications network 810 through radio frequency (RF) links 802, 808 via base stations 804, 809. The mobile telecommunications network 810 may be in compliance with any commercially available mobile telecommunications standard such as, for example, GSM, UMTS, D-AMPS, CDMA2000, FOMA and TD-SCDMA or other such suitable communication standard or protocol.

The mobile telecommunications network 810 may be operatively connected to a wide area network 820, which may be the Internet or a part thereof. An Internet server 822 has data storage 824 and can be connected to the wide area network 820, as is for example, an Internet client computer 826. UPnP devices described herein may be connected to the network 820 or computer 826. The server 822 may host a www/wap server capable of serving www/wap content to the mobile terminal 800. In alternate embodiments, the server 822 can host any suitable transaction oriented protocol.

For example, a public switched telephone network (PSTN) 830 may be connected to the mobile telecommunications network 810 in a familiar manner. Various telephone terminals, including the stationary telephone 832, may be connected to the PSTN 830.

The mobile terminal 800 is also capable of communicating locally via a local link 801 to one or more local devices 803. The local link 801 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The above examples are not intended to be limiting, and any suitable type of link may be utilized. The local devices 803 may include UPnP devices connected to antennas and supporting equipment forming a WLAN implementing Worldwide Interoperability for Microwave Access (WiMAX, IEEE 802.16), WiFi (IEEE 802.11x) or other communication protocols. The WLAN may be connected to the Internet. The mobile terminal 800 may thus have multi-radio capability for connecting wirelessly using mobile communications network 810, WLAN or both. Communication with the mobile telecommunications network 810 may also be implemented using WiFi, WiMax, or any other suitable protocols, and such communication may utilize unlicensed portions of the radio spectrum (e.g. unlicensed mobile access (UMA)).

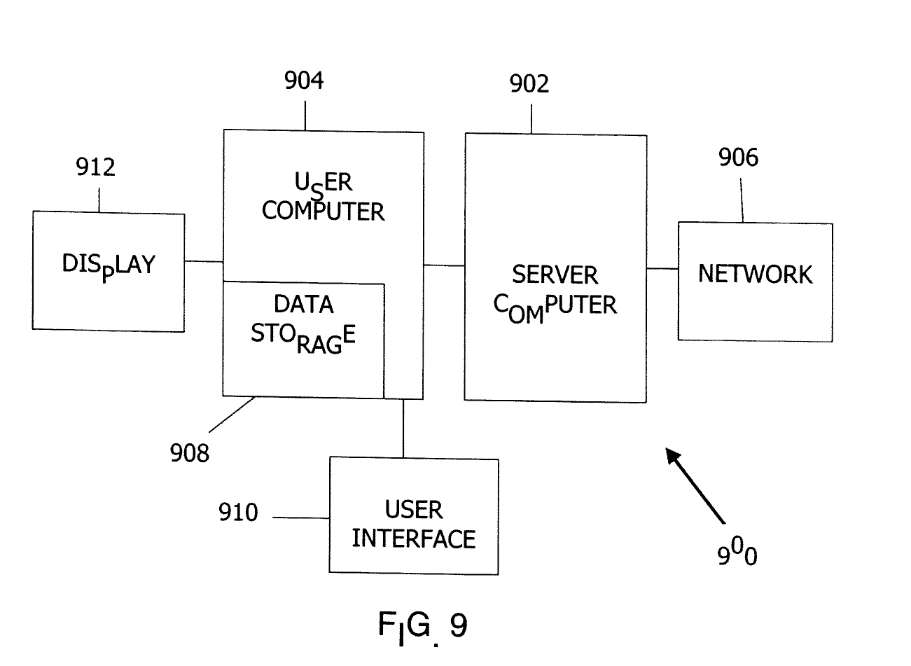

The disclosed embodiments may also include software and computer programs incorporating the process steps and instructions described above that are executed in different computers. FIG. 9 is a block diagram of one embodiment of a typical apparatus 900 incorporating features that may be used to practice aspects of the invention. The apparatus 900 can include computer readable program code means for carrying out and executing the process steps described herein. As shown, a computer system 902 may be linked to another computer system 904, such that the computers 902 and 904 are capable of sending information to each other and receiving information from each other. In one embodiment, computer system 902 could include a server computer adapted to communicate with a network 906. Computer systems 902 and 904 can be linked together in any conventional manner including, for example, a modem, hard wire connection, or fiber optic link. Generally, information can be made available to both computer systems 902 and 904 using a communication protocol typically sent over a communication channel or through a dial-up connection on ISDN line. Computers 902 and 904 are generally adapted to utilize program storage devices embodying machine-readable program source code, which is adapted to cause the computers 902 and 904 to perform the method steps, disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 902 and 904 may also include a microprocessor for executing stored programs. Computer 902 may include a data storage device 908 on its program storage device for the storage of information and data. The computer program or software incorporating the processes and method steps incorporating aspects of the invention may be stored in one or more computers 902 and 904 on an otherwise conventional program storage device. In one embodiment, computers 902 and 904 may include a user interface 910, and a display interface 912 from which aspects of the invention can be accessed. The user interface 910 and the display interface 912 can be adapted to allow the input of queries and commands to the system, as well as present the results of the commands and queries.

The disclosed embodiments provide a powerful way for users to search and obtain more content responsive to the search by allowing a user to be able to search UPnP devices coupled to a network using a traditional search engine or facility. Users can also more easily share content of their UPnP devices with other users, when appropriate access rights are provided. Users do not have to copy the content of their UPnP devices to servers from the devices in order to search and/or share the content. A mediator device is coupled to a network access point of the network. The mediator device is configured to interface with each UPnP device coupled to the user' system. The mediator device can interpret search requests and retrieve content that is stored on each UPnP device. When a search request is generated from the search engine of the system, not only will the contents of the user's system be searched, but the contents of the UPnP devices can also be searched. Depending on the search criteria, the search may also encompass the Internet. The mediator can appear as a HTTP server to the search engine. Thus, the mediator can translate the search request, and retrieve content from the UPnP devices that is responsive to the request. In one embodiment, the mediator can index the content of the UPnP devices and stored the indexed content in a database. If needed, the mediator will be configured to translate or format search results or content from the UPnP devices into a format suitable for the search engine. Users may also be able to enter search queries and receive search results referring to the content in the various UPnP devices. Thus, the mediator device will make content from UPnP devices in a user's system accessible to search facilities, search requests and request to share content.

It is noted that the embodiments described herein may be utilized separately or in any combination thereof.

It should be understood that the foregoing description is only illustrative of the embodiments. Various alternatives and modifications can be devised by those skilled in the art without departing from the embodiments. Accordingly, the disclosed embodiments are intended to embrace all such alternatives, modifications and variances that fall within the scope of the appended claims.

What is claimed is:

1. A method comprising:
providing a mediator at an access point in a network, the mediator being configured to communication with UPnP devices coupled to the network;
detecting a search request from a search engine in the network;
using the mediator to search and retrieve content from each UPnP device coupled to the network, the retrieved content being related to the search request;
converting the retrieved content into a protocol suitable for the search engine; and
passing the retrieved content from the mediator to the search engine.

2. The method of claim 1, further comprising the mediator being configured to appear as an HTTP server to the search engine.

3. The method of claim 1, further comprising the mediator being configured to detect a protocol of the search engine and convert the retrieved content according to the protocol.

4. The method of claim 1, further comprising the mediator retrieving and storing content from each UPnP device as each device is coupled to the network.

5. The method of claim 4, further comprising the mediator interpreting the search request, searching the stored content, and transmitting stored content responsive to the request to the search engine.

6. The method of claim 4, wherein the content from each UPnP device is stored and indexed in a memory local to and associated with the mediator.

7. The method of claim 4, wherein the content from each UPnP device is stored and indexed in a memory in the network associated with the search engine so that a search engine database is populated with the content from each UPnP device.

8. The method of claim 1, further comprising restricting third party access to certain UPnP content when a UPnP device is connected to a public network.

9. The method of claim 1, wherein converting the retrieved content includes mapping UPnP protocols to internet protocols.

10. An apparatus comprising:
a computing network;
at least one computing device coupled to the network;
at least one device compliant with the Universal Plug and Play standard coupled to the network; and
a mediator system coupled to the network, the mediator system configured to be an interface between a search facility of the at least one computing device and each at least one device coupled to the network, wherein the mediator is further configured to:
detect a search request from the search facility;
search and retrieve content from each UPnP device coupled to the network, the retrieved content being related to the search request;
convert the retrieved content into a protocol suitable for the search facility; and
pass the retrieved content from the mediator to the facility.

11. The apparatus of claim 10, wherein the mediator is further configured to appear as an HTTP server to the search engine.

12. The apparatus of claim 10, wherein the mediator is further configured to detect a protocol of the search engine and convert the retrieved content according to the protocol.

13. The apparatus of claim 10, wherein the mediator is further configured to retrieve and store content from each UPnP device as each device is coupled to the network.

14. The apparatus of claim 13, wherein the mediator is further configured to interpret the search request, search the stored content, and transmit stored content responsive to the request to the search engine.

15. The apparatus of claim 13, wherein the content from each UPnP device is stored and indexed in a memory local to and associated with the mediator.

16. The apparatus of claim 13, wherein the content from each UPnP device is stored and indexed in a memory in the network associated with the search engine so that a search engine database is populated with the content from each UPnP device.

17. The apparatus of claim 10, wherein the mediator is further configured to restrict third party access to certain UPnP content when a UPnP device is connected to a public network.

18. The apparatus of claim 10, wherein the mediator is further configured to convert the retrieved content by mapping UPnP protocols to internet protocols.

19. A computer program product comprising:
a computer useable medium having computer readable code means embodied therein for causing a computer to execute a set of instructions in a device to search for UPnP content in UPnP devices, the computer readable code means in the computer program product comprising:
computer readable program code means for causing a computer to detect a search request from a search engine in the network;
computer readable program code means for causing a computer to search and retrieve content from each UPnP device coupled to the network, the retrieved content being related to the search request;
computer readable program code means for causing a computer to convert the retrieved content into a protocol suitable for the search engine; and
computer readable program code means for causing a computer to pass the retrieved content from the mediator to the search engine.

20. The computer program product of claim 19, wherein the computer is configured to appear as an HTTP server to the search engine.
